(19) United States
(12) Patent Application Publication
(10) Pub. No.: US 2026/0365016 A1
(43) Pub. Date: Nov. 19, 2026

(54) Display System Comprising a Screen Display Device and a Status Display Area

(71) Applicant: Bayerische Motoren Werke Aktiengesellschaft, Muenchen (DE)

(72) Inventor: Philipp HOFFMANN, Hannover (DE)

(21) Appl. No.: 19/487,052

(22) PCT Filed: Jul. 24, 2024
(86) PCT No.: PCT/DE2024/100654

§ 371 Date: Nov. 24, 2025

(30) Foreign Application Priority Data
Sep. 5, 2023 (DE) 10 2023 123 877.9

(51) Int. Cl. B60K 35/22; B60K 35/231; B60K 35/28; G02B 27/01

(52) U.S. Cl. CPC B60K 35/22; B60K 35/231; B60K 35/28; G02B 27/0101; B60K 2360/1523; B60K 2360/178; B60K 2360/693; G02B 2027/0112

(57) ABSTRACT

A display system for providing image information in a screen display area and a selectively displayable status symbol in a status display area includes a screen display device having a pixel matrix for presenting the image information; a plurality of parallel, in particular stacked, planar light-guiding elements that are arranged plane-parallel to the extent of the pixel matrix and adjacent to the screen display device, wherein the light-guiding elements are each provided with at least one coupling-out region via which light coupled into the light-guiding element can be coupled out perpendicularly to the status display area, wherein the coupling-out region is in the shape of a displayable status symbol; and a deflection device which is configured to couple light from at least one pixel or from pixels of at least one corresponding partial region of a peripheral region of the pixel matrix laterally into each of the light-guiding elements.

### BACKGROUND AND SUMMARY

The invention relates to display systems comprising an image display device for outputting arbitrary image information via a pixel matrix and a status display area.

In general, screen display devices having a pixel matrix, such as LCD displays, OLED displays, micro-LED displays, and the like are used to provide visual information. Generally available screen display devices are generally only obtainable in specific formats and sizes.

In vehicles, the screen display devices enable the input and output for implementing entertainment, navigation, and other assistance functions for the vehicle occupants in a comfortable manner. However, the installation space limitation presents problems to the producers in the selection of screen display devices due to the restricted selection of formats and sizes.

In addition, simple status displays are also necessary in vehicles in addition to the display of image information. Such status displays are fixed in location and enable a vehicle status, a warning, or an error to be displayed to the user or the driver. These status displays have been implemented up to this point by signal lights in the instrument panel.

The use of screen display devices is to fundamentally enable the status displays to be moved to the screen display area of the screen display device (screen surface). However, such status displays are provided to signal errors and warnings and are therefore important, so they should not be overlaid or even covered by other information. Therefore, a status display area has to be reserved on the screen display devices, in which exclusively such status displays are to be displayed. However, this reduces the available display area for the output of other relevant vehicle functions, in particular with respect to entertainment, navigation, and other assistance functions.

However, it is not easily possible to enlarge the screen display device, since only fixed formats and sizes are offered by the producers of the screen display devices. They typically cannot be readily fitted into the available installation space, so that often the next smaller embodiment of the screen display device is selected which fits into the available installation space.

It is therefore the object of the present invention to provide a display system which, in addition to a screen display device, also provides a status display area and enables degrees of freedom in the selection of the format of the display system.

This object is achieved by the display system comprising a screen display device and a status display area according to the claimed invention.

According to one aspect, a display system for providing image information in a screen display area and a selectively displayable status symbol in a status display area, in particular for use in a console of a vehicle, is provided, comprising:
a screen display device comprising a pixel matrix for displaying the image information;
multiple planar light guiding elements which are parallel to one another, in particular stacked, and are arranged surface-parallel to the extension of the pixel matrix adjacent to the screen display device, wherein the light guiding elements are each provided with at least one decoupling area, via which light coupled into the respective light guiding element can be decoupled perpendicular to the status display area, wherein the decoupling area has the shape of a displayable status symbol; and
a deflection device which is designed to laterally couple light of at least one pixel or of pixels of at least one corresponding section of an edge area of the pixel matrix into each of the light guiding elements.

The above display system enables the expansion of a screen display area of a screen display device with a status display area, which adjoins an edge of the screen display area. The screen display device has a screen display area and is preferably designed as a matrix display comprising a pixel matrix. The screen display device can comprise a micro-LED display device, an OLED display device, or an LCD display device, wherein the pixels of the pixel matrix are selectively actuatable to output light of a specific color. Image information can be displayed in a known manner on the screen display device, which can be perceived by looking down on the upper side of the display system.

The deflection device can guide light from one or more pixels in the edge area of the pixel matrix via a mirror arrangement or another light guide (such as optical fibers for laterally deflecting the light emitted by the pixels) laterally to the coupling areas of the multiple light guiding elements. The edge area can be provided at one or more edges of the pixel matrix with a width of 1 to 10 pixels in each case.

Status displays, which are arranged in a status display area, for example in the instrument panel, are generally provided in vehicles. The status display area has planar transparent light guiding elements in the form of light guiding planes, into which light can be coupled selectively via a laterally arranged coupling area, i.e., for example, via an edge, and which define the decoupling areas in the form of status symbols. The decoupling areas enable the exit of coupled-in light perpendicular to the surface direction or extension direction of the light guiding elements, so that they are perceptible by looking down on an upper side of the display system. The status symbols correspond to defined shapes, such as symbols for signaling an engine error, an excess temperature, a notification to fill wiper fluid, and the like. The status symbols, i.e. the decoupling areas in the light guiding elements, can be provided at different positions or overlaid on one another with respect to the main surface direction.

The decoupling areas can become/be formed by changing the optical property of the material or the surface of the light guiding elements, for example by roughening.

The light guiding elements can be formed from a transparent material, such as PMMA, in the form of layers, films, or the like and can have a thickness of between 0.1-2 mm. Light coupled into a light guiding element results in decoupling on the at least one decoupling area, so that the status symbol is accordingly perceptible on the upper side of the status display area. Each of the light guiding elements is optically coupled via the deflection device with one or more pixels in an edge area of the screen display device, so that upon activation of the corresponding pixels the resulting display light is coupled into the corresponding light guiding element, propagates in the light guiding element, and results at the decoupling area in the display of the status symbol. Therefore, a symbol assigned to the light guiding element can be displayed or not displayed by the selective actuation of the corresponding pixels.

A common transparent cover pane can be provided, the upper side of which forms the screen display area and the status display area, wherein the screen display device is connected via a connecting layer to the lower side of the cover pane and wherein the multiple light guiding elements in the status display area are fastened directly on the lower side of the cover pane. The screen display area and the status display area can therefore be formed or covered by a common transparent cover pane, so that the impression of a contiguous display results.

At least one of the coupling areas can be provided with a color filter for the selective coupling in of light, in order to only couple light of a specific light color into the relevant light guiding element and not to couple in light of another light color.

Such a display system enables the display area to be significantly enlarged at its edge with respect to the format and the size of the screen display device used, so that available formats of the screen display device can be used in order to enable various sizes for the display area of the display system. In particular with micro-LED pixels of a micro-LED screen display device, the luminosity of a few pixels is already sufficient to light up and display a perceptible status symbol in a typical size and with sufficient luminosity.

According to one embodiment, a decoupling light guide of the deflection device can be provided in each case for several of the light guiding elements, which couples a section of the edge area of the pixel matrix into a relevant light guiding element.

Furthermore, the edge area can be provided at each of one or more edges of the pixel matrix with a width of 1 to 20 pixels, in particular 5 to 10 pixels.

Embodiments will be explained in more detail hereinafter on the basis of the appended drawings.

### BRIEF DESCRIPTION OF THE DRAWINGS

FIG. 1 shows a top view of a display system having a display area designed to output image information and to output status displays.

FIG. 2 shows a cross-sectional view through the display system of FIG. 1.

FIGS. 3a and 3b show examples of light guiding elements having decoupling areas which indicate status symbols.

FIG. 4 shows a more detailed cross-sectional view of the deflection device between the pixel matrix and the coupling areas of the light guiding elements.

### DETAILED DESCRIPTION OF THE DRAWINGS

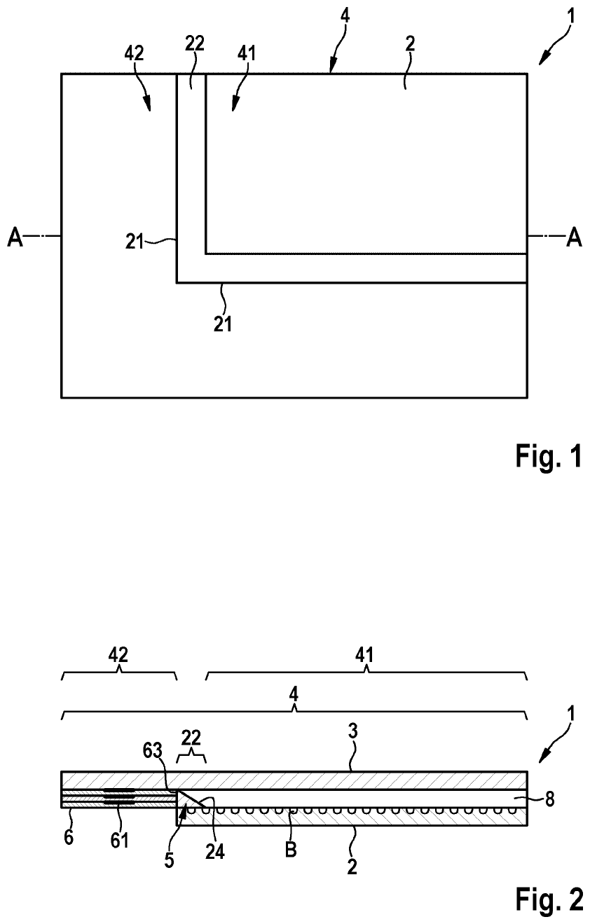

An exemplary display system 1 is shown in the top view of FIG. 1 and the cross-sectional view of FIG. 2.

The display system 1 has a screen display device 2 comprising a pixel matrix, which can be designed, for example, from self-luminescent pixels B arranged adjacent to one another, for example in the form of micro-LEDs. The screen display device 2 defines a screen display area 41, via which variable image information can be displayed.

A cover pane 3 is arranged above the screen display area 41 of the screen display device 2, which is transparent so that image information output by the screen display device 2 is perceptible by looking down on an overall display area 4. A connecting layer 8, which represents a transparent material that can be used, for example, as an adhesive or adhesion layer, is provided between the upper side of the screen display device 2 and the lower side of the cover pane 3 facing toward the screen display device 2. The transparent material is selected so that a visual perceptibility of the image information through the cover pane 3 on the screen display area 41 is not impaired.

The cover pane 3 is extended in the surface direction over one to four (two here) edges 21 of the screen display device 2 and therefore forms a status display area 42 outside the screen display area 41, which is not capable of outputting variable image information displayable using pixels, but rather is only designed to display predetermined status symbols. One or more planar light guiding elements 6 are arranged, in particular stacked, on the lower side of the cover pane 3 in the status display area, each of which defines a light guiding plane, in which coupled-in light is guided.

An optical deflection device 5 is provided between the cover pane 3 and the screen display device 2 in an edge area 22 of the pixel matrix of the screen display device 2, in order to couple light of the pixels B of the edge area 22 via a respective coupling area 62 at a lateral edge of the light guiding elements 6 facing toward the screen display device 2 into a relevant one of the light guiding elements 6.

The light guiding elements 6 are light guides designed as planar, which are made of a transparent material, such as PMMA, and are arranged surface-parallel below the status display area at the lower side of the cover pane 3, in particular in a stacked arrangement. The light guiding elements 6 conduct light coupled in laterally and offer the possibility of decoupling light at decoupling areas 61 at the respective upper side, which are designed corresponding to the shape of the status symbol to be displayed, so that the decoupling area 61 can be perceived. The formation of the coupling area 61 can be carried out, for example, by roughening the surface of the light guiding element 6 or other optical techniques in the light guiding elements 6.

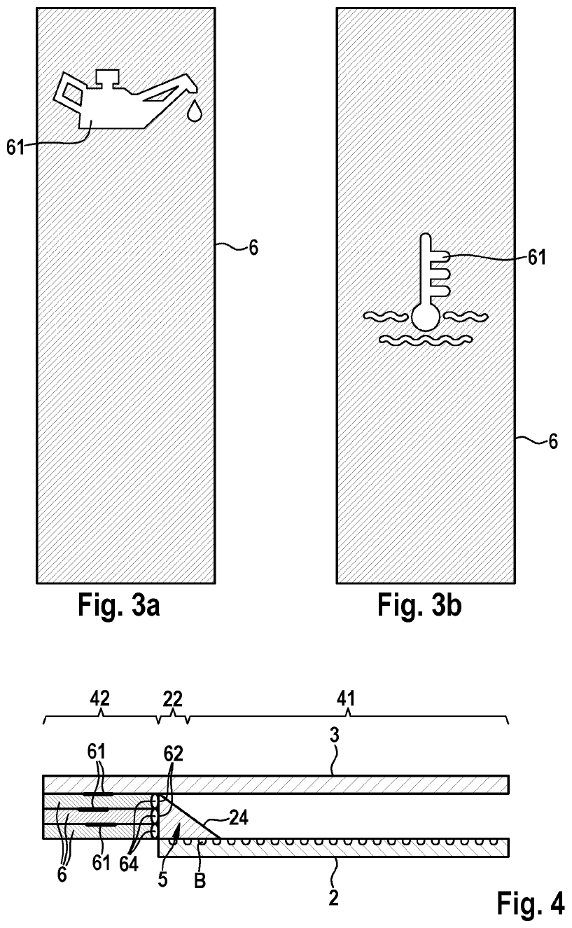

Examples of such light guiding elements 6 are shown in FIGS. 3a and 3b, comprising decoupling areas 61 which indicate displayable status symbols. These status symbols can be displayed in different colors for each light guiding element 6 for the display.

Due to the transparent design of the light guiding elements 6, decoupling areas 61 can also be arranged overlaid on one another, so that if light of various colors is coupled in, mixed colors can be provided to display the status symbols at decoupling areas 61 overlapping one another.

The thickness of the light guiding elements 6 is preferably selected to be between 0.1 and 2 mm and depends in particular on the number of the light guiding elements 6 to be provided. The total thickness of the stacked arrangement of the light guiding elements 6 is not to exceed a thickness of between 1 to 3 mm, since the upper side of the screen display device 2 and lower side of the cover pane 3, which are opposite to one another, also have to be spaced apart from one another by this distance without worsening perception of the image information. If the distance between the cover pane 3 and the pixel matrix of the screen display device 2 is excessively large, optical effects can occur via the connecting layer 8 which can worsen the perceptibility of the displayed image information. Moreover, the decoupling of light from pixels B in the edge area 22 of the pixel matrix and coupling into the light guiding planes 6 also has to be enabled.

The edge area 22 of the pixel matrix is therefore not available for the output of the image information via the screen display area 41, but rather is used to selectively illuminate the status display area.

The selective coupling into the light guiding planes 6 can take place in that sections of the edge area 22 are coupled with a respective light guiding plane 6 via a corresponding deflection device 5. In other words, the selective coupling can take place so that each of the light guiding planes is optically connected by optical coupling to a part of an edge area of the pixel matrix, so that by selectively actuating the pixels of a part of the edge area, light can be coupled into the corresponding light guiding plane in order to illuminate the status symbol provided there.

It is therefore possible by way of the selective actuation of the pixels in the edge area 22 of the pixel matrix to selectively couple light into individual light guiding elements 6, so that the status symbols can be switched to be visible and nonvisible via the status display area 42, depending on which of the sections each having one or more pixels are switched on or switched off.

As shown in the cross-sectional view of FIG. 4, the deflection device 5 can be formed, for example, with the aid of a mirror arrangement 24 arranged at an angle between 30 and 60°, preferably 45°, above the edge area 22 of the pixel matrix, in order to couple light of the pixels B of the edge area 22 into one or more light guiding elements 6.

The coupling areas 63 of the light guiding elements 6 can be provided with color filters 64 in order to only permit light of the corresponding color to be coupled in and/or to selectively couple in light of a specific color and filter out or block light of other colors. The status symbol is thus only displayed in the decoupling area 61 if the pixels in the edge area of the pixel matrix output light of the corresponding color. For example, a red filter/blue filter/green filter can be provided in the coupling area 62 of one of the light guiding elements 6 in order to only couple in light of the corresponding color.

FIG. 4 shows a possible design of the coupling of light from the edge area of the pixel matrix into the light guiding elements 6. Light can thus be laterally deflected from the edge area 22 of the pixel matrix with the aid of a mirror arrangement 24 and coupled into the light guiding elements 6 via the respective coupling areas 62. If color filters 64 are provided in the coupling area 62 of the respective light guiding elements 6, colored light of specific wavelengths can be filtered out deliberately in order, by corresponding actuation of the pixels in the edge area 22 of the pixel matrix, to thus only couple light into specific light guiding elements 6, display the status symbols provided there, and not display the status symbols of the other light guiding elements 6.

Alternatively to the mirror arrangement 24, by providing a coupling light guide for each light guiding element 6, a specific section of the edge area of the pixel matrix can be directly connected to the relevant light guiding element 6, so that light coupling of the specific area of the pixel matrix can be performed directly into the light guiding element. For this purpose, the coupling light guide can be placed directly on the surface of the pixel matrix and optically connected in a light-guiding manner to the coupling area 62 without scattering effects occurring there.

The rear side of the screen display device 2 and/or the rear side of the status display area 42 can be provided with a black layer to avoid a transparency of the display system 1, so that the perceptibility of displayed status symbols and the image information is improved.

### LIST OF REFERENCE SIGNS

1 display system
2 screen display device
21 edges of the screen display device
22 edge area
24 mirror arrangement
3 cover pane
4 display area
41 screen display area
42 status display area
5 deflection device
6 light guiding elements
61 decoupling area
63 coupling area
64 color filter
8 connecting layer
B pixels

1.-7. (canceled)

8. A display system for providing image information in a screen display area and a selectively displayable status symbol in a status display area, the display system comprising:
a screen display device comprising a pixel matrix having pixels for displaying the image information;
a plurality of planar light guiding elements which are parallel to one another and are arranged surface-parallel to an extension of the pixel matrix adjacent to the screen display device, wherein the light guiding elements are each provided with at least one decoupling area via which light coupled into the respective light guiding element can be decoupled perpendicularly to the status display area, wherein the decoupling area is shaped in a shape of a displayable status symbol; and
a deflection device which is configured to couple light of at least one pixel or of pixels of at least one corresponding section of an edge area of the pixel matrix laterally into each of the light guiding elements.

9. The display system according to claim 8, wherein the light guiding elements are stacked.

10. The display system according to claim 8, wherein the screen display device comprises an LCD display device, a micro-LED display device, or an OLED display device.

11. The display system according to claim 8, wherein:
a common transparent cover pane is provided, the upper side of which cover pane forms the screen display area and the status display area,
the screen display device is connected via a connecting layer to a lower side of the cover pane, and
the light guiding elements in the status display area are fastened directly to the lower side of the cover pane.

12. The display system according to claim 8, wherein the deflection device guides light from one or more pixels in the edge area of the pixel matrix via a mirror arrangement laterally to coupling areas of the light guiding elements.

13. The display system according to claim 12, wherein at least one of the coupling areas is provided with a color filter in order to only couple light of a specific light color into the respective light guiding element and not to couple in light of another light color.

14. The display system according to claim 8, wherein a coupling light guide of the deflection device is provided in each case for several of the light guiding elements, which coupling light guide couples a section of the edge area of the pixel matrix into a respective light guiding element.

15. The display system according to claim 8, wherein the edge area is provided at each of one or more edges of the pixel matrix with a width of 1 to 20 pixels.

16. The display system according to claim 8, wherein the edge area is provided at each of one or more edges of the pixel matrix with a width of 5 to 10 pixels.
